(19) United States
(12) Patent Application Publication
(10) Pub. No.: US 2017/0193305 A1
(43) Pub. Date: Jul. 6, 2017

(54) FLASH FLOODING DETECTION SYSTEM

(71) Applicant: AGT INTERNATIONAL GMBH, Zurich (CH)

(72) Inventors: Yaacov APELBAUM, Sayville, NY (US); Guy LORMAN, Kfar Saba (IL)

(21) Appl. No.: 15/313,005

(22) PCT Filed: May 18, 2015
(86) PCT No.: PCT/EP2015/060919

§ 371 Date: Nov. 21, 2016

(30) Foreign Application Priority Data
Jun. 16, 2014 (SG) 10201403287V

(51) Int. Cl. G06K 9/00; G08B 21/10; H04N 7/18

(52) U.S. Cl. CPC G06K 9/00744; H04N 7/181; G06K 9/00771; G06K 9/0063; G08B 21/10

(57) ABSTRACT

A system and methods for detecting, forecasting, and alerting of flash flooding conditions. Multiple video cameras are deployed in open areas over a region, each of which monitors a visible marker affixed to a ground-level surface such as a street or road. Surface water over a marker alters the visible characteristics thereof, which are captured by the camera monitoring the marker. Camera output is processed by video analytics and machine vision techniques to analyze the changes in visibility, which are compared against pre-existing reference data related to flash flooding, to extract indicia of flash flooding. Results derived from multiple cameras over the region are correlated to detect patterns indicative of flash flooding, and appropriate reports, alerts, and warnings are issued.

### BACKGROUND

Flooding is an overflow of water that submerges normally-dry land, and is a common hazard in many areas in world. Floods range in geographical extent from local, impacting a neighborhood or community, to broadly regional, affecting entire river basins and multiple states. Reliable flooding forecasting can greatly assist in protecting life and property by providing advance warning.

Some flooding builds slowly over a time of days to weeks, while certain floods, known as “flash floods”, can develop rapidly over a period of minutes to hours, sometimes without any visible signs of rain. Flash flooding is characterized by elevated water in open areas, non-limiting examples of which include streets and roads. Flash floods are particularly dangerous for life and property, notably transportation equipment and infrastructure.

Most current weather sensing and warning systems are based on wind, humidity, rain and temperature measurements, cloud observation, Doppler radar, and satellite telemetry. Rain gauges measure only continuous precipitation at specific locations. Doppler radar works well only with large-scale weather features such as frontal systems; moreover, Doppler radar is limited to flat terrain, because radar coverage is restricted by beam blockage in mountainous areas. In addition, radar measurements can be inaccurate: in drizzle and freezing conditions, Doppler readings can seriously misrepresent the amount of precipitation. Satellite-based detection is representative only of cloud coverage, and not actual precipitation at ground level. All of these technologies require models to translate sensed data into reliable flooding forecasts. None of them give any real-time indication about the actual state of flowing water, and are thus generally ineffective for detecting and predicting flash floods.

Technologies do exist for detecting flooding in real time by providing sensor information for automatic processing. However, these technologies are not based on visual camera sensing and automated analytic methods. Camera sensing coupled with analytics offers the advantage of not only automatically detecting flash flooding conditions visually for early warning, but can also be used simultaneously and subsequently to visually inspect the situation in real time.

It would therefore be highly desirable and advantageous to have an effective camera-based system for accurately monitoring and predicting flash flooding conditions. This goal is met by the present invention.

### SUMMARY

Embodiments of the present invention provide monitoring, detection, and forecasting specifically of flash flooding conditions, and provide early alert of possible flash flooding in areas such as cities, critical facilities, transportation systems, and the like.

According to some embodiments the present invention provides a system for monitoring and detection of flash flooding events, the system comprising:
a plurality of visual markers for placement on open area ground surfaces;
a plurality of video cameras for obtaining captured visual images of at least one of the visual markers;
a plurality of video analytics units for analyzing the captured visual images of the visual markers, for detecting surface water covering of one or more of the visual markers; and
a logic unit, for correlating data from at least one of the video analytics units and at least one of the video cameras, for relating surface water distributions on at least one of the visual markers to at least one flash flooding condition, and for issuing at least one notification relating to the flash flooding condition.

According to some embodiments the present invention provides a method for monitoring and detection of flash flooding events, comprising:
placing a plurality of visual markers on open area ground surfaces;
providing a plurality of video cameras for obtaining captured visual images of at least one of the visual markers;
analyzing the captured visual images of the visual markers, for detection of surface water covering of one or more of the visual markers, by a plurality of video analytics units;
correlating data from at least one of the video analytics units and at least one of the video cameras, by a logic unit, for relating surface water distributions on the visual markers to at least one flash flooding condition; and
issuing at least one notification relating to the flash flooding condition.

According to some embodiments the present invention provides a computer readable medium (CRM), for example in transitory or non-transitory form, that, when loaded into a memory of a computing device and executed by at least one processor of the computing device, configured to execute the steps of a computer implemented method for monitoring and detection of flash flooding events.

The term “flash flooding condition” herein denotes any condition relating to a flash flood, including a condition that no flash flooding is likely, or that no flash flooding has been detected.

To detect flash flooding conditions and provide early warning capabilities, embodiments of the invention use video cameras for monitoring visual markers (herein also denoted simply as “markers”) placed on open area ground surfaces which potentially may be covered with water during and/or leading up to a flash flooding event. The term “open area” herein denotes that the area is unenclosed to air and water and is exposed to outdoor weather and flooding conditions. The camera outputs are processed by video analytics and machine vision techniques to detect changes in marker visibility caused by surface water over the markers. The markers are suited for installation on open areas such as roads and streets, allowing broad geographical coverage for detection and assessment of flash flooding events.

In addition, the same cameras which are used to detect and forecast potential flash flooding may also be used to visually inspect the area, to monitor and verify the severity of the flash flooding, and to visually verify if there are any people, vehicles, or other property present in the danger zone.

### BRIEF DESCRIPTION OF THE DRAWINGS

The subject matter disclosed may best be understood by reference to the following detailed description when read with the accompanying drawings in which:

FIG. 1 conceptually illustrates an example of a marker on a road, as monitored by a video camera according to an embodiment of the present invention.

FIG. 2A illustrates a block diagram of a system according to an embodiment of the invention, for a camera monitoring a dry marker.

FIG. 2B illustrates the block diagram of the system of FIG. 2A according to another embodiment of the invention, for the camera monitoring the marker when covered to a certain degree by surface water.

FIG. 2C illustrates the block diagram of the system of FIG. 2B according to a further embodiment of the invention, for the camera monitoring the marker covered to a different degree by surface water.

As illustrated in FIG. 2B and FIG. 2C, in addition to distinguishing surface water covering a visual marker from a dry visual marker, an embodiment of the present invention provides a capability of distinguishing multiple different degrees, for a non-limiting example, at least one of length, depth, area, or volume measurement, of covering a marker by surface water.

FIG. 3 conceptually illustrates a networked arrangement according to an embodiment of the present invention, whereby multiple cameras connect to a server for gathering data over a geographical region for analysis and presentation of reports and forecasts related to flash flooding conditions throughout the region.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

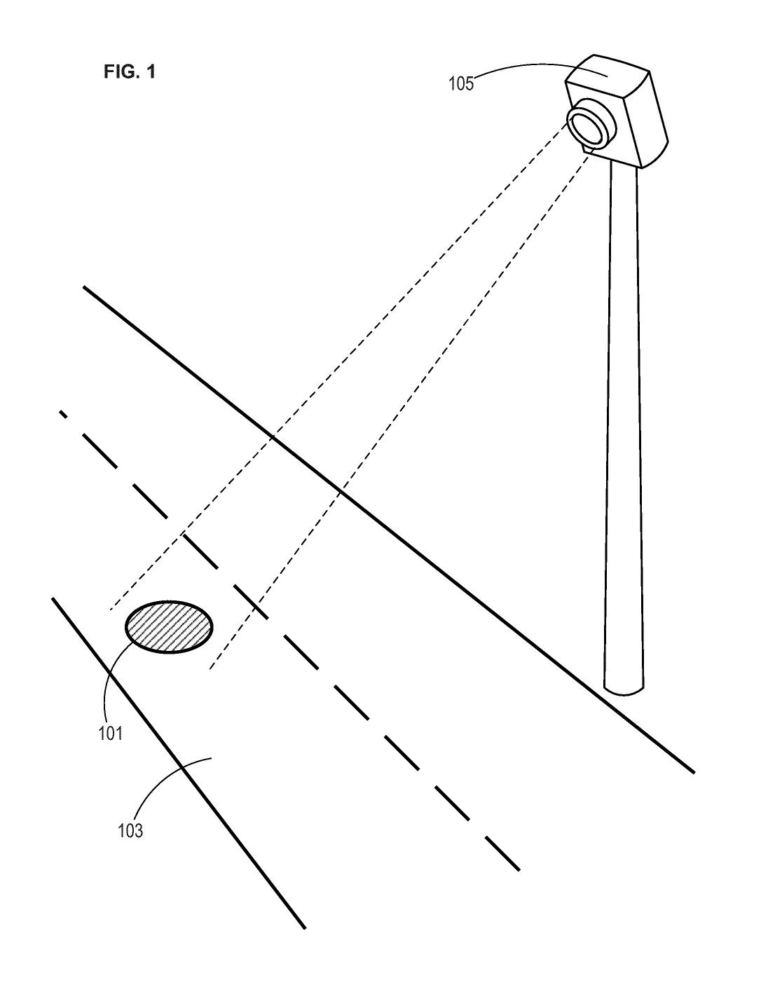

FIG. 1 conceptually illustrates a marker 101 on a road surface 103, as monitored by a video camera 105 according to an embodiment of the present invention. In other embodiments, a marker can be placed on other surfaces in open areas. Streets and roads are often utilized because they are usually in open areas, and they generally provide good and extended locations for monitoring. According to additional embodiments of the present invention, the ground surfaces upon which markers are placed are in low-lying areas which may be prone to flash flooding.

According to an embodiment of the present invention, marker 101 is a passive visual element, including, but not limited to: a painted or printed pattern, a plaque, and a sticker, which is suitable for application to a surface, such as a road or street. The term “passive” with reference to a visual marker herein denotes that the marker does not output any visual light on its own, but relies on reflection, scattering, and/or absorption of ambient light for its visual appearance According to another embodiment, marker 101 is an active visual device, incorporating light-emitting components including, but not limited to: an electrical light, and an electroluminescent panel, which may be powered by mains, and/or battery, and/or solar panel.

In an embodiment of the invention, video camera 105 is a digital camera, and in another embodiment, video camera 105 is an analog camera. In a further embodiment, video camera 105 is capable of providing still pictures and images. In still another embodiment, the field of view of video camera 105 extends substantially beyond the extent of marker 101 and includes the scene surrounding marker 101.

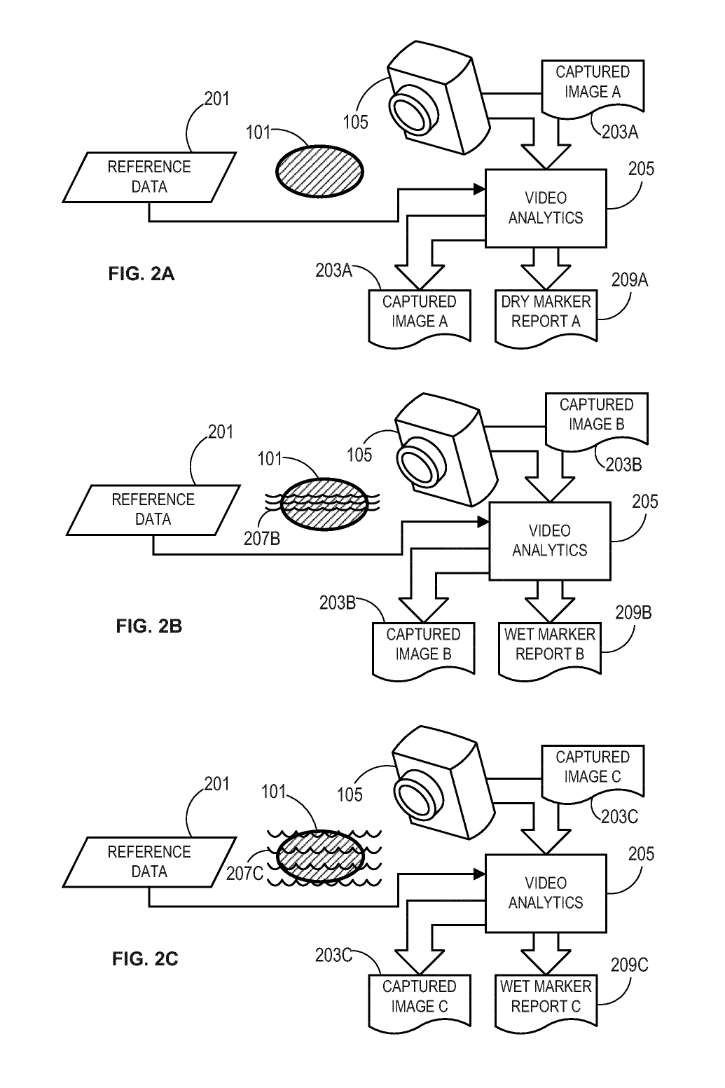

FIG. 2A illustrates a block diagram of a system according to an embodiment of the invention, for camera 105 monitoring marker 101 in a dry condition. A captured video image A 203A is output from camera 105 into a video analytics unit 205, which compares video image A 203A against reference data 201 to analyze video image A 203A regarding the relevance thereof to possible flash flooding. In particular, video analytics unit 205 determines that marker 101 is in a dry condition, and then issues a dry marker report A 209A for subsequent data processing (as disclosed below).

FIG. 2B illustrates the system of FIG. 2A, for camera 105 monitoring of marker 101 in a wet condition, when marker 101 is covered to a certain degree by surface water 207B. A captured video image B 203B is output from camera 105 into video analytics unit 205, which compares video image B 203B against reference data 201 to analyze video image B 203B regarding the relevance thereof to possible flash flooding. In particular, video analytics unit 205 determines that marker 101 is covered to a certain degree by surface water 207B, and then issues a wet marker report B 209B for subsequent data processing (as disclosed below).

FIG. 2C illustrates the system of FIG. 2A, for camera 105 monitoring of marker 101 in a wet condition, when marker 101 is covered to a different degree by surface water 207C. A captured video image C 203C is output from camera 105 into video analytics unit 205, which compares video image C 203C against reference data 201 to analyze video image C 203C regarding the relevance thereof to possible flash flooding. In particular, video analytics unit 205 determines that marker 101 is covered to a different degree by surface water 207C, and then issues a wet marker report C 209C for subsequent data processing (as disclosed below).

In another embodiment of the invention, video analytics unit 205 also makes captured video images, (e.g., video image A 203A, video image B 203B, and video image C 203C) available for subsequent data processing.

In summary, the video stream from camera 105 is processed by video analytics unit 205, which applies machine vision and/or image processing techniques to detect when marker 101 is dry (FIG. 2A), or is covered to varying degrees by surface water (surface water 207B in FIG. 2B, surface water 207C in FIG. 2C) during or leading up to an incident of flash flooding.

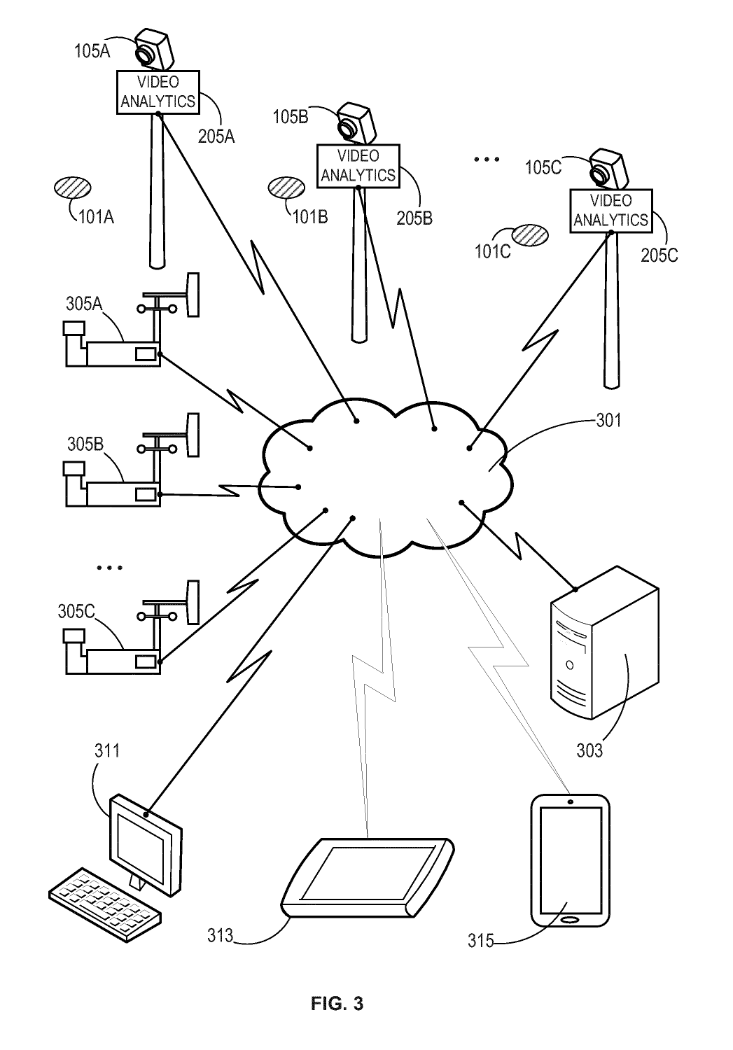

FIG. 3 conceptually illustrates a networked arrangement according to an embodiment of the present invention, whereby multiple visual markers 101A, 101B, . . . , 101C are respectively monitored by multiple cameras 105A, 105B, . . . , 105C respectively having multiple video analytics units 205A, 205B, . . . , 205C which connect via a network 301 to a server 303 for gathering data over a geographical region for analysis and presentation of reports and forecasts related to flash flooding conditions throughout the region.

In various embodiments of the invention, server 303 performs as a logic unit which correlates data from multiple video analytics units 205A, 205B, . . . , 205C and/or multiple cameras 105A, 105B, . . . , 105C respectively monitoring visual markers 101A, 101B, . . . , 101C, for relating surface water distributions thereon to flash flooding conditions, and for issuing notifications relating to the flash flooding conditions. A notification includes, but is not limited to: a report of a flash flooding condition, a report of an absence of a flash flooding condition, a forecast of a flash flooding condition, and an alert (or warning) of a flash flooding condition, as disclosed below.

In an embodiment of the present invention, one or more weather stations, such as a weather station 305A, a weather station 305B, and a weather station 305C, provide additional detection of weather conditions for correlation with video analytics, and contribute to reference data 201 (FIGS. 2A, 2B, and 2C).

According to further embodiments of the invention, server 303 receives and correlates additional data to improve the quality of flash flooding event detection—such as by increasing the confidence level of positive flash flooding event detection by reducing or eliminating false positive and false negative flash flooding detection. In a related embodiment, each detection from a video analytics unit is correlated with additional detections, such as by the same video analytics unit at a different time, or from nearby video analytics units in different places, such as neighboring areas. In other related embodiments, a detection from a video analytics unit is correlated with information including, but not limited to: data from flooding conductivity sensors or rain gauge sensors of a weather station; calibration data to correlate visual analytic results with direct measurements of surface water on a marker; weather condition data; and historical data from previous flooding events.

According to further embodiments of the invention, cross correlation between camera sensor visual marker detections are performed by a logic unit utilizing techniques including, but not limited to: rule engines; complex event processing (CEP); data fusion with neighboring camera sensors; and machine learning.

In certain embodiments, video analytics units include dedicated hardware devices or components. In other embodiments, video analytics units are implemented in software, and software. In various related embodiments, video analytics units are deployed in or near the video cameras; in other related embodiments, video analytics units are embedded within server 303, which directly receives the video stream from the cameras over network 301.

According to an embodiment of the invention, flash flooding-related notifications, include, but are not limited to: reporting, advisory bulletins, analyses, updates, and warnings. In a related embodiment, these are distributed to subscribers via user-edge equipment, such as a personal computer/workstation 311, a tablet computer 313, and a telephone 315, such as by a web client or other facility. In another related embodiment, distribution is performed via messaging techniques including, but not limited to: API calls, SMS, MMS, e-mail, and other messaging services.

In further embodiments of the present invention, visual media content is sent with a flooding detection alert. Visual media content includes, but is not limited to: live video and/or audio streaming from the detected event; short recorded video clips; still images; and audio clips. Visual media content can assist first responders or the general public in validating the event, assessing the situation, and deciding on appropriate responses.

1. A system for monitoring and detection of flash flooding events, the system comprising:
a plurality of visual markers for placement on open area ground surfaces;
a plurality of video cameras for obtaining captured visual images of at least one of the visual markers;
a plurality of video analytics units for analyzing the captured visual images of the visual markers, for detecting surface water covering of one or more of the visual markers; and
a logic unit, for correlating data from at least one of the video analytics units and at least one of the video cameras, for relating surface water distributions on at least one of the visual markers to at least one flash flooding condition, and for issuing at least one notification relating to the flash flooding condition.

2. The system of claim 1, wherein the video cameras and the video analytics units are operative to distinguish a plurality of different degrees of surface water covering the visual markers.

3. The system of claim 1, wherein at least one of the visual markers is on a low-lying ground surface.

4. The system of claim 1, wherein a captured visual image from at least one of the video cameras includes a scene surrounding at least one of the visual markers.

5. The system of claim 4, wherein at least one of the video analytics unit is configured to send visual media content to the logic unit.

6. The system of claim 5, wherein the visual media content comprises at least one selected from a group consisting of:
live video streaming;
live audio streaming;
video clips;
still images; and
audio clips.

7. The system of claim 1, wherein the notification comprises at least one selected from a group consisting of:
a report of a flash flooding condition;
a report of an absence of a flash flooding condition;
a forecast of a flash flooding condition; and
an alert of a flash flooding condition.

8. The system of claim 7, wherein the notification is sent to at least one subscriber via at least one messaging technique selected from a group consisting of:
an API call;
SMS;
MMS; and
e-mail.

9. The system of claim 1, wherein a detection of a flash flooding condition by at least one of the video analytics unit is correlated with information comprising at least one selected from a group consisting of:
a detection by the same video analytics unit at a different time;
a detection by a different video analytics unit at a different place;
data from a flooding conductivity sensor;
data from a rain gauge sensor;
calibration data to correlate a visual analytic result with a direct measurement of surface water on a visual marker;
weather condition data; and
historical data from previous flooding events.

10. The system of claim 1, wherein the logic unit is configured to perform a cross-correlation between visual marker detections utilizing a technique comprising at least one selected from a group consisting of:
a rule engine;
complex event processing (CEP);
data fusion with neighboring camera sensors; and
machine learning.

11. The system of claim 1, wherein an open area ground surface comprises at least one selected from a group consisting of:
a road; and
a street.

12 The system of claim 1, wherein each of the visual markers comprises at least one selected from a group consisting of:
a passive element; and
an active device.

13. A method for monitoring and detection of flash flooding events, comprising:
placing a plurality of visual markers on open area ground surfaces;
providing a plurality of video cameras for obtaining captured visual images of at least one of the visual markers;
analyzing the captured visual images of the visual markers, for detection of surface water covering of one or more of the visual markers, by a plurality of video analytics units;
correlating data from at least one of the video analytics units and at least one of the video cameras, by a logic unit, for relating surface water distributions on the visual markers to at least one flash flooding condition; and
issuing at least one notification relating to the flash flooding condition.

14. The method of claim 13, wherein the video cameras and the video analytics units are operative to distinguish a plurality of different degrees of surface water covering the visual markers.

15. The method of claim 13, wherein at least one visual markers is placed on a low-lying ground surface.

16. The method of claim 13, wherein a captured visual image from at least one of the video cameras includes a scene surrounding at least one of the visual markers.

17. The method of claim 16, wherein at least one of the video analytics unit is configured for sending visual media content to the logic unit.

18. The method of claim 17, wherein the visual media content comprises at least one selected from a group consisting of:
live video streaming;
live audio streaming;
video clips;
still images; and
audio clips.

19. The method of claim 13, wherein the notification comprises at least one selected from a group consisting of:
a report of a flash flooding condition;
a report of an absence of a flash flooding condition;
a forecast of a flash flooding condition; and
an alert of a flash flooding condition.

20. The method of claim 19, further comprising sending the notification to at least one subscriber via at least one messaging technique selected from a group consisting of:
an API call;
SMS;
MMS; and
e-mail.

21. The method of claim 13, wherein a detection of a flash flooding condition by at least one of the video analytics unit is correlated with information comprising at least one selected from a group consisting of:
a detection by the same video analytics unit at a different time;
a detection by a different video analytics unit at a different place;
data from a flooding conductivity sensor;
data from a rain gauge sensor;
calibration data to correlate a visual analytic result with a direct measurement of surface water on a visual marker;
weather condition data; and
historical data from previous flooding events.

22. The method of claim 13, wherein the logic unit is configured for performing a cross-correlation between visual marker detections utilizing a technique comprising at least one selected from a group consisting of:
a rule engine;
complex event processing (CEP);
data fusion with neighboring camera sensors; and
machine learning.

23. The method of claim 13, wherein an open area ground surface comprises at least one selected from a group consisting of:
a road; and
a street.

24. The method of claim 13, wherein each of the visual markers comprises at least one selected from a group consisting of:
a passive element; and
an active device.

25. A computer readable medium (CRM) that, when loaded into a memory of a computing device and executed by at least one processor of the computing device, configured to execute the steps of a computer implemented method for monitoring and detection of flash flooding events, according to claim 13.
